(19) United States
(12) Patent Application Publication
(10) Pub. No.: US 2015/0319254 A1
(43) Pub. Date: Nov. 5, 2015

(54) DEFAULT INITIAL FILTER CRITERIA

(71) Applicant: TELEFONAKTIEBOLAGET L M ERICSSON (PUBL), Stockholm (SE)

(72) Inventors: Cormac Hegarty, BROMMA (SE); Mattias Dahlqvist, Stockholm (SE); Jonas Falkenå, Huddinge (SE)

(73) Assignee: TELEFONAKTIEBOLAGET L M ERICSSON (PUBL), Stockholm (SW)

(21) Appl. No.: 14/650,006

(22) PCT Filed: Dec. 7, 2012
(86) PCT No.: PCT/EP2012/074847

§ 371 Date: Jun. 5, 2015

(51) Int. Cl. H04L 29/08

(52) U.S. Cl. CPC H04L 67/16; H04L 67/32

(57) ABSTRACT

Methods and apparatus are provided for operating a network element in an Internet Protocol Multimedia Subsystem network including a plurality of application servers. The network element receives a user request associated with a user. The user request is applied to a collection of Initial Filter Criteria associated with the user. If an Initial filter Criteria fires, then normal processing of the user request continues. However, if none of the Initial Filter Criteria fires, then default triggering logic determines the session associated with the user request is not recognised or is unknown. The default triggering logic applies the user request to one or more default iFCs, which include selection criteria defining one or more rules or conditions associated with rejecting or processing the user request (e.g. forwarding to an application server or continuing processing the user request at the network element).

### TECHNICAL FIELD

The present invention relates to a method for operating a network element in an Internet Protocol Multimedia Subsystem (IMS) network to apply a user request to a collection of Initial Filter Criteria (iFCs) associated with the user and, when a session associated with the user request is not recognised, to reject or process the user request based on default iFC logic.

### BACKGROUND

IP Multimedia services provide a dynamic combination of voice, video, messaging, data, etc. within the same session. By growing the number of basic applications and the media which it is possible to combine, the number of services offered to the end subscribers will grow, and the inter-personal communication experience will be enriched. This will lead to a new generation of personalised, rich multimedia communication services, including so-called “combinational IP Multimedia” services.

IMS is the technology defined by the Third Generation Partnership Project (3GPP) and ETSI TISPAN group to provide IP Multimedia services over mobile communication networks. IMS provides key features to enrich the end-subscriber person-to-person communication experience through the use of standardised IMS Service Enablers, which facilitate new rich person-to-person (client-to-client) communication services as well as person-to-content (client-to-server) services over IP-based networks. The IMS makes use of the Session Initiation Protocol (SIP) to set up and control calls or sessions between user equipment (UE) (e.g. subscriber terminals and application servers (ASs)). The Session Description Protocol (SDP), carried by SIP signalling, is used to describe and negotiate the media components of the session. Whilst SIP was created as a subscriber-to-subscriber protocol, IMS allows operators and service providers to control subscriber access to services and to charge subscribers accordingly.

By way of example, FIG. 1 illustrates schematically how the IMS fits into the mobile network architecture in the case of a GPRS/PS access network (IMS can of course operate over other access networks). The mobile network architecture includes many network elements, some of which are described herein such as Call/Session Control Functions (CSCFs), which operate as SIP proxies within the IMS. The 3GPP architecture defines three types of CSCFs: the Proxy CSCF (P-CSCF) which is the first point of contact within the IMS for a SIP terminal; the Serving CSCF (S-CSCF) which provides services to the subscriber (or user) that the user is subscribed to; and the Interrogating CSCF (I-CSCF) whose role is to identify the correct S-CSCF and to forward to that S-CSCF a user request from the UE received via a P-CSCF.

A UE may comprise or represent any device used for communications. Examples of UE that may be used in certain embodiments of the described network(s) are wireless devices such as mobile phones, terminals, SIP terminals, smart phones, portable computing devices such as lap tops, handheld devices, tablets, net books, computers, personal digital assistants and other wireless communication devices, or wired communication devices such as telephones, computing devices such as desktop computers, set-top boxes, and other fixed communication devices.

A network element may comprise or represent any network node, device, function, or entity for use in a telecommunications network which can be managed over a specific interface. Examples of network elements that may be used in certain embodiments of the described network(s) are network elements, nodes, devices, functions, or entities that make up core network(s), access network(s) such as packet or circuit switched network(s), IP based networks, 2G, 3G, 4G and next generation networks, IMS core network, IMS service network, and service and external networks and the like. Other examples include the network elements such as those illustrated in FIG. 1.

A user request may comprise or represent any type of request, signalling or message sent from a UE to a network or network element for establishing a session or service associated with the UE. Examples of user requests that may be used in certain embodiments of the described network(s) are session requests, service requests, originating call requests, terminating call requests, SIP requests (including methods like INVITE or REGISTER messages, etc.) related to a SIP session or service, or any other request based on any other protocol sent from a user via a UE to the network in relation to a session or requested service.

Although the IMS network is used and described herein by way of example only, where user requests from UEs may be carried over the IMS network based on SIP signalling/messaging (e.g. SIP requests), it is to be appreciated by the skilled person that other networks and messaging or signalling protocols may also be used (e.g. HTTP based signalling carrying Extensible Mark-up Language Configuration Access Protocol (XCAP) for self management of supplementary services from the user).

Referring to FIG. 1, within the IMS service network, Application Servers (ASs) are provided for implementing IMS service functionality. ASs provide services to end users in an IMS system, and may be connected either as end-points over the 3GPP defined Mr interface, or “linked in” by an S-CSCF over the 3GPP defined ISC interface. In the latter case, iFCs are used by an S-CSCF to determine which ASs should be “linked in” during a SIP Session establishment (or indeed for the purpose of any SIP method, session or non-session related). A user's profile (or subscriber's Subcriber Profile) may contain one or more iFCs or a collection of iFCs, which are a collection of triggers that determine when a user request (e.g. a SIP Session establishment or SIP request) is forwarded to an AS for providing the service/session. Typically iFCs are received by the S-CSCF from a home subscriber server (HSS) during the IMS registration procedure as part of a user's or subscriber's Subscriber Profile.

3GPP Technical Specification 29.228 describes the structure of the filter criteria of iFCs in the user profile. It further describes how the trigger points and SPTs (Service Point Triggers) should be interpreted (e.g. SIP Header class defines SPT for the presence or absence of any SIP header or for the content of any SIP header). 3GPP TS 24.229 also briefly refers to how iFCs may be handled by the S-CSCF. iFCs allow dynamic handling of user requests (e.g. service/session requests or SIP requests) based on the user's profile and are a filter-and-redirect signalling mechanism used in the S-CSCF.

For example, when the request is a SIP request, the S-CSCF might apply filter criteria to determine the need to forward the SIP request to an AS that can handle the request. An iFC may be composed of an AS address (or AS Uniform Resource Identifier (URI)) where the request is to be forwarded in case of a match, and a Trigger Point element in the form of a logical rule or condition which is verified against initial dialog creating SIP requests or stand-alone SIP requests. Services for the originating party will be applied in the originating network, while the services for the terminating party will be applied in the terminating network, all in the respective S-CSCFs.

However, the configuration of iFCs (as defined in the standards) is complex and each user requires their own customised configuration based on their service plans or options that can be set for each user. To deal with all “eventualities” or all possible user requests from a UE, a complex iFC configuration for each user is required with an extensive iFC policy evaluation being performed in the S-CSCF. With the implementation of Voice over Long Term Evolution (VoLTE), operators are beginning to discover that this type of iFC configuration is unwieldy and too costly to perform on a per user basis.

It has been recognised that standardized iFC configurations also do not enable an operator to deal efficiently with a session associated with a user request that the network has no knowledge of (e.g. when a user requests a service that is not part of their service plan). If such a request is received and the policy iFC evaluation in S-CSCF does not match a configured trigger then the request will be forwarded on in the network. For the majority of VoLTE operators “a user request that the network has no knowledge of” is typically recognised as a fraud case and the session associated with the request will be refused. However, as IMS supports a multitude of services and Rich Communication Suite (RCS)-e is beginning to gain traction in the market, there is an increased likelihood that the network will receive user requests that the network has no knowledge of, which will result in sessions associated with these legitimate user requests being refused (i.e. mistaken as a fraud case).

There is a significant desire to simplify the configuration of iFC policies for users while at the same time efficiently processing sessions associated with legitimate user requests that the network has no knowledge of.

### SUMMARY

In order to address or solve the problems identified above, it is proposed to introduce a method for recognising when to perform further processing of sessions associated with legitimate user requests that are unrecognised. The method includes triggering default iFC (DiFC) logic when a session associated with a user request is unrecognised to further process the user request to minimise refusal of session associated with a legitimate user request (e.g. a service/session request) as a fraud case.

According to a first aspect of the invention there is provided a method for operating a network element in an IMS network including a plurality of ASs. The method includes receiving a user request associated with a user from a UE. Applying a collection of iFCs associated with the user to the user request. Determining whether the session associated with the user request is recognised. Applying one or more default iFCs (DiFCs) to the user request when the session associated with the user request is not recognised, where the DiFCs include selection criteria defining one or more rules associated with rejecting or allowing processing of the user request.

Optionally, the step of applying one or more DiFCs to the user request further includes determining whether the user request matches the selection criteria of an applied default iFC. Forwarding the user request to an AS for processing or rejection when the user request matches the selection criteria of the applied DiFC and the applied DiFC includes the AS address. The user request is processed by the network element when the user request matches the selection criteria of the applied DiFC and the applied DiFC does not include an AS address.

As an option, the step of applying one or more DiFCs to the user request further includes determining whether a further DiFC may be applied to the user request when the applied DiFC does not include an AS address. Applying the further DiFC to the user request when it is determined a further DiFC may be applied. Processing the user request by the network element based on the applied DiFC when it is determined a further DiFC may not be applied to the user request.

As another option, the step of applying one or more default iFCs to the user request further includes determining whether the user request matches the selection criteria of an applied DiFC. Determining whether to reject the user request via an AS when the user request does not match the selection criteria of an applied DiFC. Forwarding the user request to an AS for rejection when the user request is determined for rejection by the AS, otherwise forwarding a rejection response from the network element to the UE associated with the user request.

As an option, the step of applying one or more DiFCs to the user request further includes determining whether the user request matches the selection criteria of an applied DiFC. Forwarding the user request to an AS for processing or rejection when the user request matches the selection criteria of the applied DiFC and the applied DiFC includes the AS address. Processing or rejecting the user request by the network element when the applied DiFC does not include an AS address.

Optionally, the step of applying one or more DiFCs to the user request further includes determining whether the user request matches the selection criteria of an applied DiFC for allowing processing of the user request. Forwarding the user request to an AS for processing when the user request matches the selection criteria of the applied DiFC and the applied DiFC includes the AS address. Forwarding the user request to an AS for rejection when the user request does not match the selection criteria of the applied DiFC and the applied DiFC includes the AS address. Processing or rejecting the user request by the network element when the applied DiFC does not include an AS address.

As a further option, the step of processing or rejecting the user request further includes determining whether the user request matches the selection criteria of a further applied DiFC. Forwarding the user request to an AS for processing when the user request matches the selection criteria of the further applied DiFC and the further applied DiFC includes the AS address. Forwarding the user request to an AS for rejection when the user request does not match the selection criteria of the further applied DiFC and the further applied DiFC includes the AS address. Processing or rejecting the user request by the network element when the further applied DiFC does not include an AS address.

As an option, the step of forwarding the user request to an AS for rejection further includes forwarding the user request to the AS for rejection when the user request does not match the selection criteria of all further applied DiFCs.

Optionally, the selection criteria of the applied DiFC comprises a default trigger point element including one or more service point triggers that define at last one of the one or more rules for rejecting or allowing processing of the user request when the session/service associated with the user request is not recognised.

As another option, the step of applying the collection of iFCs to the user request further includes determining the session/service associated with the user request to be recognised when the user request matches at least one iFC in the collection and continuing processing of the user request when the session/service associated with the user request is recognised.

As an option, the DiFCs are stored within the network element. As another option, the method includes the step of receiving the DiFCs from a further node or network element in the IMS network (e.g. an HSS). Optionally, the method includes updating the DiFCs from the further network element. Additionally or alternatively, the DiFCs are separate from the collection of iFCs associated with a user, and/or the DiFCs are not part of the collection of iFCs associated with the user profile or user subscription. Optionally, the network element includes the functionality of an S-CSCF.

According to a second aspect of the invention there is provided a network element for use in an IMS network including a plurality of ASs. The network element includes a receiver, a transmitter, memory, and processing logic, the processing logic being connected to the receiver, the transmitter and the memory. The receiver is configured to receive a user request associated with a user. The processing logic includes trigger logic configured to apply a collection of iFCs associated with the user to the user request. The processing logic further includes default trigger logic configured to determine whether the session/service associated with the user request is recognised. The default trigger logic is further configured to apply one or more DiFCs to the user request when the session/service associated with the user request is not recognised. The DiFCs include selection criteria defining one or more rules associated with rejecting or allowing processing of the user request.

As an option, the default trigger logic is further configured to determine whether the user request matches the selection criteria of an applied DiFC. The default trigger logic and the transmitter are further configured to forward the user request to an application server when the user request matches the selection criteria of the applied DiFC and the applied DiFC includes the application server address. The default trigger logic is further configured to process the user request when the user request matches the selection criteria of the applied DiFC and the applied DiFC does not include an AS address.

Optionally, the default trigger logic may be further configured to determine whether a further default iFC may be applied to the user request when the applied default iFC does not include an AS address. Apply the further DiFC to the user request when it is determined a further DiFC may be applied, and process the user request when it is determined a further DiFC may not be applied to the user request.

As an option, the default trigger logic is further configured to determine whether the user request matches the selection criteria of an applied DiFC, determine whether to reject the user request via an AS when the user request does not match the selection criteria of an applied default iFC. The default trigger logic and transmitter are then further configured to forward the user request to an AS for rejection when it is determined to reject the user request via an AS, and forward a rejection response to the UE associated with the user request when it is determined not to reject the user request via an AS.

Optionally, the default trigger logic is further configured to determine whether the user request matches the selection criteria of an applied DiFC. The default trigger logic and the transmitter are further configured to forward the user request to an AS when the user request matches the selection criteria of the applied DiFC and the applied DiFC includes the AS address. The default trigger logic is further configured to process or reject the user request when the applied DiFC does not include an AS address.

As an option, the default trigger logic is further configured to determine whether the user request matches the selection criteria of an applied DiFC associated with allowing processing of the user request. The default trigger logic and transmitter are further configured to forward the user request to an AS for processing when the user request matches the selection criteria of the applied DiFC and the applied DiFC includes the AS address. The default trigger logic and transmitter are further configured to forward the user request to an AS for rejection when the user request does not match the selection criteria of the applied DiFC and the applied DiFC includes the AS address. The default trigger logic is further configured to process or reject the user request when the applied DiFC does not include an AS address.

As an option, the default trigger logic is further configured to determine whether the user request matches the selection criteria of a further applied DiFC. The default trigger logic and transmitter are further configured to forward the user request to an AS for processing when the user request matches the selection criteria of the further applied DiFC and the further applied DiFC includes the AS address. The default trigger logic and transmitter are further configured to forward the user request to an AS for rejection when the user request does not match the selection criteria of the further applied DiFC and the further applied DiFC includes the AS address.

Optionally, the default trigger logic and transmitter are further configured to forward the user request to the AS for rejection when the user request does not match the selection criteria of all further applied DiFCs.

As an option, the selection criteria of each of the one or more DiFCs may include a default trigger point element including one or more service point triggers defining at least one of the one or more rules or conditions for rejecting, processing, or allowing the processing of the user request when the session/service associated with the user request is not recognised.

As another option, the triggering logic is further configured to determine the session associated with the user request to be recognised when at least one iFC in the collection of iFCs matches the user request, and forward the user request for normal call processing when the session/service associated with the user request is recognised.

As an option, memory is configured to store the DiFCs within the network element. As another option, the receiver is configured to receive the DiFCs from a further node or network element in the IMS network (e.g. an HSS), and the memory is configured to store the DiFCs. This allows an operator to centrally store and update the DiFCs, which will allow each network element to update the one or more DiFCs used by the default trigger logic. Additionally or alternatively, the DiFCs are stored separately from the collection of iFCs associated with a user in the network element and/or a further node or network element in the IMS. The DiFCs are not part of the collection of iFCs associated with user profiles or user subscriptions. Optionally, the network element includes the functionality of an S-CSCF. As an option, the user request is a session request, a service request or a SIP Session Establishment message. As another option, the user request is a SIP request from the UE.

Embodiments of the present invention can provide a relatively simple and efficient mechanism for allowing a network operator to minimise the complexity of iFC configuration for each user while enabling the network to take into account session requests that are unknown to the network.

The invention provides the advantages of enabling smooth VoLTE deployment (e.g. ensuring fraud cases can be legitimately handled) by simplifying iFC configuration and enabling a more effective iFC policy evaluation criterion. iFC configuration for each user is simplified because the operator only needs to handle known user requests associated with the user's profile or service plan. The operator does not need to configure user iFCs on a per user basis to handle all eventualities or all possible user requests outside the user's profile or service plan, instead operators can remove this associated exception handling from current user iFC configurations because these exceptions can be handled by the DiFCs centrally in the network element. In addition, the invention provides the advantage of allowing an operator to decide how to handle “unknown” user requests in a central location (e.g. the network element such as an S-CSCF) and allowing the network to process or serve the request where possible (e.g. to provide specific instructions to the user or UE on how the request may be served etc., or allowing end-users to automatically/conveniently upgrade their subscription and serve the request). The default iFC mechanism may be applied in both in the originating and terminating sides of a network and can be used for any SIP protocol element or extended to cover generic fault cases/rejections if required.

### BRIEF DESCRIPTION OF THE DRAWINGS

In order that the invention may be more fully understood, some of the embodiments of the invention will now be described, by way of example only, with reference to the accompanying drawings, in which:

FIG. 1 illustrates schematically a telecommunications network including an IMS network, a 3G mobile communications system, access networks and user equipment;

FIG. 2 illustrates schematically an example network element according to the invention;

FIG. 3a is a flow diagram illustrating an example process for operating a network element according to the invention;

FIG. 3b is a flow diagram illustrating another example process for operating a network element according to the invention;

FIG. 4a is a flow diagram illustrating a further example process for operating a network element according to the invention;

FIG. 4b is a flow diagram illustrating yet a further example process for operating a network element according to the invention; and

FIG. 5 illustrates schematically an example of a network element suitable for implementing the methods described herein.

### DETAILED DESCRIPTION

In order to address the problems identified above, it is proposed to introduce a mechanism to allow network elements to determine how to handle unrecognised sessions associated with user requests (e.g. session/service or call requests) and/or user requests. This is implemented by introducing into the network element a default triggering logic that is configured to handle the unrecognised sessions or requests gracefully. Handling of such sessions and requests may be configured by operators giving the network element a default policy on how the session associated with the request should be handled. For example, unrecognised requests/sessions may be handled by playing an announcement outlining how to ensure the request or requested service/session can be served; providing a link to the user where they can obtain instructions on how their request/service/session can be served; rejecting the request/session gracefully; forwarding the request/session to a “fraud-handling” AS; route-on in the network etc.

The invention is based on the concept of default operator/network iFC triggering which enables a session associated with a user request that is not recognized by the serving network to be treated in a specific fashion. Typically, when information (e.g. iFC policy) for serving a request or session is not available in the standardized iFC method (e.g. no iFC has matched in the S-CSCF rule engine) then an operator/network steered default iFC (DiFC) (or collection of DiFCs or one or more DiFCs) should fire. This can result in an AS deciding on what actions should be taken (e.g. indicate to the user how to ensure the network can serve the requested session/service) or reject the user request directly without involving an AS.

As the DiFC policy is operator/network steered there is no need to provision the DiFC policy on a per user basis as compared with the standardised iFC configuration per user. This dramatically simplifies iFC configuration for each user as it is not necessary to deal with all “eventualities” of user requests that a user of a UE may make. The DiFC mechanism is designed to centrally handle all the “eventualities” of user requests that are not defined in the iFC configuration of the user. In addition, the DiFC mechanism can be used in both the originating and the terminating network.

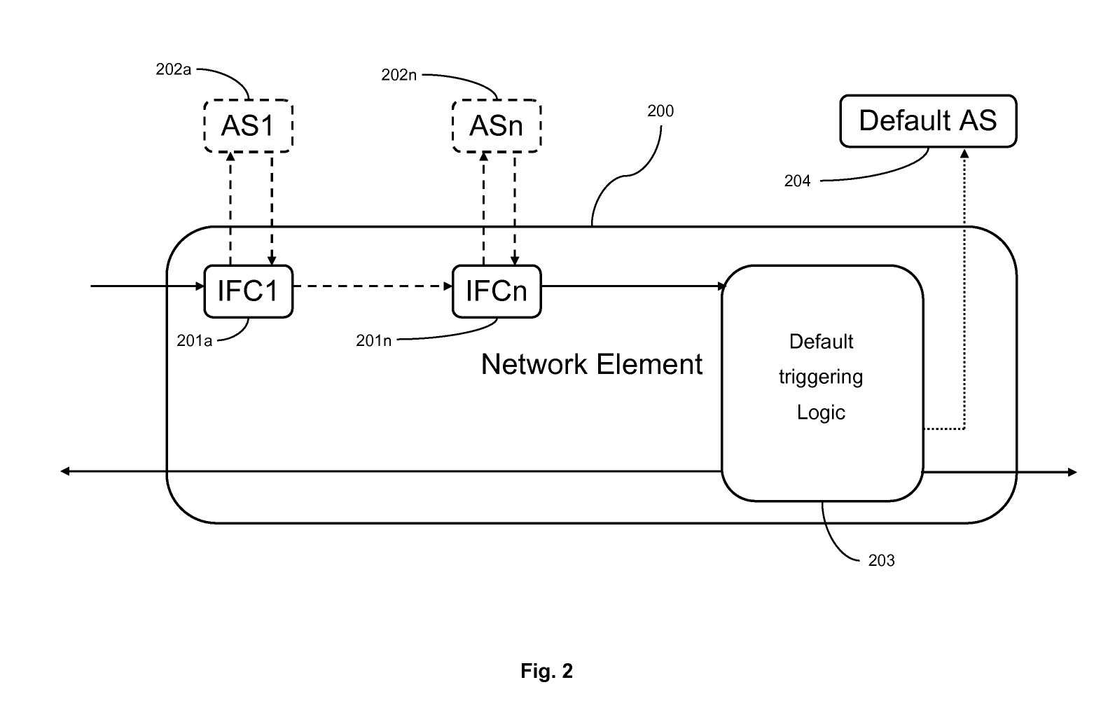

FIG. 2 illustrates schematically an example network element 200 according to the invention. The network element 200 includes the functionality of an S-CSCF and in some embodiments is an S-CSCF. The network element 200 has access to or includes a collection of iFCs 201a-201n (e.g. a set of one or more iFCs) associated with the user. The collection of iFCs 201a-201n are associated with a user profile for use in treating a user request (e.g. a session/service request or a SIP request) and typically forwarding the request an appropriate AS (e.g. AS1-ASn) 202a-202n for further call processing etc. Each iFC in the collection of iFCs 201a-201n typically includes filter criteria representative of rules or conditions for use in deciding whether an AS is contacted or not in relation to the user request. On receiving a user request from a UE, the network element 200 applies the collection of iFCs 201a-201n to the user request to determine which AS 202a-202n should be contacted regarding the user request.

The collection of iFCs 201a-201n are filter criteria that are stored in an HSS (not shown) as part of the user profile or IMS Subscription Profile and are typically downloaded to the network element 200 upon user registration (for registered users) or on processing demand (for services, acting as unregistered users). The iFCs 201a-201n represent the provided subscription of a user to an application and are valid throughout the registration lifetime or until the user profile changes (e.g. further services are added/removed depending on the user's service plan). Once the iFCs 201a-201n associated with the user are downloaded to the network element 200, the network element 200 uses the iFCs (e.g. applies the iFCs to a user request) to determine which AS should be contacted regarding a received user request. Applying the iFCs to the user request is achieved by matching the data within the user request with the filter criteria of one of the iFCs 201a-201n. An iFC (e.g. iFC 201a) is said to have “fired” when data in the user request matches the filter criteria of the iFC (e.g. iFC 201a), which triggers the network element 200 to forward the user request to the corresponding AS (e.g. AS 202a). Typically an iFC will include an AS address (e.g. a uniform resource identifier (URI) of an AS) that is to be contacted regarding the user request or session associated with the user request.

3GPP TS 29.228 defines the structure of iFCs used in IMS networks in which there are a number of aspects included in the filter criteria that need to be defined. For example, “priority” indicating the priority for a trigger; “Trigger-Point” element which is a Boolean expression in Conjunctive or Disjunctive Normal form (CNF of DNF); “Service Point Trigger” element and allowing grouping of SPT elements that will configure the sub-expressions inside a CNF or DNF expression. Furthermore, each SPT element can also contain one of the following trigger items: “Request-Uri” which is a trigger condition based on the content of the Request-Uri of the request; “SIP Method” indicating the trigger point that is the SIP message, where the presence of the SIP message “fires” the trigger; “SIP Header” indicating whether a specific SIP header is part of the trigger evaluation; and “Session Case” indicating the traffic case (e.g. originating registered/unregistered, terminating registered/unregistered etc).

The network element 200 further includes default triggering logic 203 as a failsafe for when the session associated with the user request is determined to be unknown or unrecognised when none of the iFCs 201a-202n “fires”. That is the user request does not match any of the iFCs 201a-202n provided for by the user profile. For example, this will occur when the user request is for a session or service not provided for or anticipated for by the user profile, which means the session associated with the user request will not be recognised or is unknown. This may also occur when the user request is a fraudulent user request. The default triggering logic 203 is configured to forward the user request to a default AS 204 (or any other suitable AS 202a-202n) or allow the network element 200 to further process or reject the user request. When the session or service associated with the user request is considered to be unknown to the network or the network element 200, the default triggering logic 203 is used to handle the user request. This allows the network element 200 to gracefully reject the user request or handle the user request accordingly.

The default triggering logic 202 determines based on a configured criterion whether an iFC has previously “fired” for the user request (e.g. a requested session). If an iFC has “fired” then it is assumed that the session associated with the user request is recognised or known to the network element 200 and can be processed normally. For example, the user request may be associated with a session that belongs to the service handled by the triggered AS (e.g. towards ASn) and session signalling will continue as “normal”.

However, if none of the iFCs 201a-201n have “fired”, then the session associated with the user request is considered by the network element 200 to be unrecognised or unknown. The configured criterion of the default triggering logic 202 includes one or more DiFCs that may be configured by the operator/network. The DiFCs may be stored in the network element 200 or downloaded to the network element 200 when needed or for updating stored DiFCs. For example, the network element 200 may be configured to receive the DiFCs from a further node or network element in the IMS network (e.g. an HSS) for storage. This allows an operator to centrally store and update the DiFCs (e.g. in the HSS or other network node), which will allow each network element 200 to update the DiFCs stored in the network element 200.

As the DiFCs are used on all user requests in which the sessions associated with the user requests are unrecognised, the DiFCs are stored separately from the collection of iFCs associated with a user. For example, the DiFCs may be separate from each collection of iFCs associated with a user, and are not part of a user profile or collection of iFCs associated with the user or user's profile.

The default trigger logic 203 applies the DiFCs to the user request to determine whether the user request should be processed or rejected. For example, if a DiFC fires then a “Default AS” may be invoked which can deal with the user request (e.g. a session/service request) based on the operators policy. As an example, a VoLTE operator may use the “Default AS” as a “security AS” to verify the user request is legitimate or fraudulent etc. Alternatively, if the user request is associated with a service not provided for by the user's profile, subscription or service plan, then the operator may use the “Default AS” as a means for allowing the user to upgrade their subscription to include the requested service, and thus access the service temporarily or on a permanent basis.

The DiFCs include selection criteria defining one or more rules or conditions associated with rejecting or allowing further processing of the user request. This may include forwarding the user request to one or more ASs configured to handle the unknown/unrecognised session associated with the user request, e.g. default AS 204. Alternatively, the network element 200 may continue to process and/or reject the user request. The structure of a DiFC may be similar to that of an iFC as described. For example, the selection criteria of a DiFC may include one or more default trigger point elements, each of which include one or more service point trigger elements defining at least one of the one or more rules or conditions for rejecting or allowing processing of the user request when the session associated with the user request is not recognised.

As an example, the default trigger logic 203 may determine whether the user request matches the selection criteria of the one or more DiFCs. If a DiFC fires and the DiFC includes an AS address, then the network element 200 will be triggered to forward the user request to the AS for further processing/handling or rejection. If none of the DiFCs fires, then the default triggering logic 203 may let the network element 200 to process or reject the user request. In addition, in the absence of an AS address in a DiFC that fires, the network element 200 may also further process or reject the request.

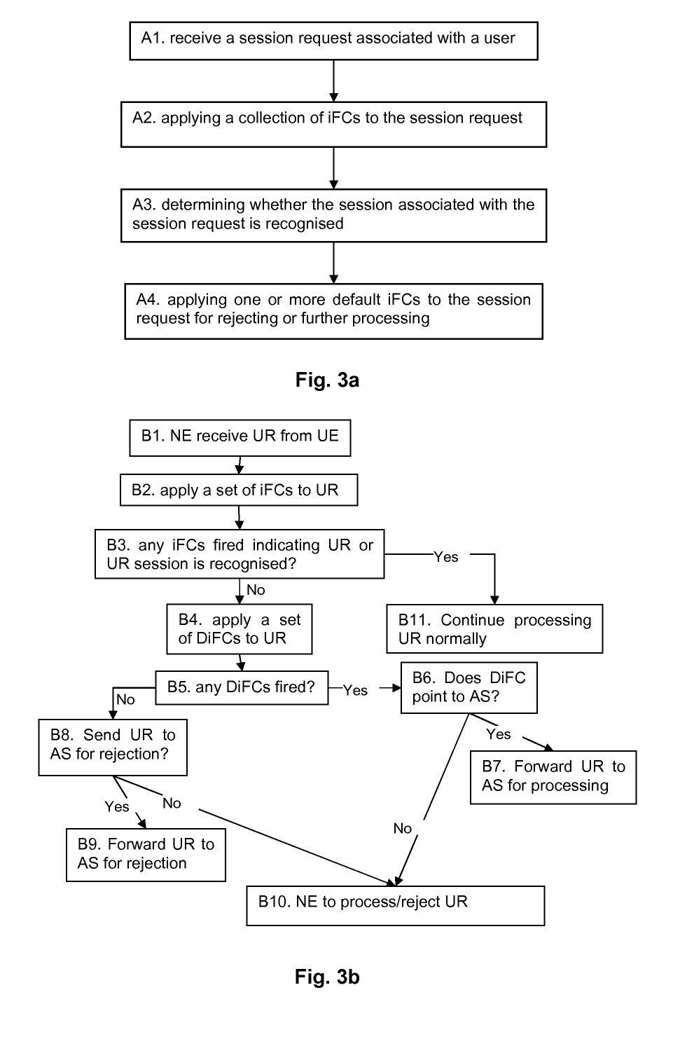

FIG. 3a is a flow diagram illustrating an example process for operating a network element according to the invention. The network element may be included in an IMS network that includes a plurality of ASs and a collection of iFCs associated with each user. The process includes the following steps:
A1. Receiving a user request (e.g. a session/service request) associated with a user equipment or user.
A2. Applying the collection of iFCs associated with the user to the user request. The collection of iFCs associated with the user may be stored in the network element or downloaded from another network entity (e.g. an HSS in the IMS network).
A3. Determining whether the user request or session associated with the user request is recognised. This may be based on whether the user request matches the filter criteria of any of the iFCs.
A4. Applying one or more DiFCs to the user request when the user request or session associated with the user request is not recognised. The DiFCs include selection criteria defining one or more rules or conditions associated with rejecting or allowing processing of the user request or session associated with the user request. The DiFCs may be locally stored on the network element or stored in another node such as an HSS and are stored separately from the collection of iFCs associated with each user (e.g. the DiFCs are not part of the collections of iFCs or part of a user profile).

FIG. 3b is a flow diagram illustrating another example process for operating a network element according to the invention. The network element may be included in an IMS network that includes a plurality of ASs and the network element. The network element may have access to a set of iFCs (e.g. a collection of iFCs) associated with a user (e.g. from the user profile in the HSS of the IMS network, or locally stored). The process includes the following steps:
B1. The network element (NE) receives a user request (UR) associated with a UE.
B2. The set of iFCs are applied to the UR.
B3. Determining whether any of the iFCs in the set of iFCs fired indicating the UR or session associated with the UR is recognised or known (e.g. a session request may be associated with a session or service that is part of the user's subscription/profile). If an iFC fired (e.g. Yes), then proceed to step B11. Otherwise, if none of the iFCs fired (e.g. No), then proceed to step B4.
B4. Applying a set of DiFCs (e.g. one of more DiFCs) to the UR.
B5. Determining whether any of the DiFCs in the set of DiFCs fired indicating the UR may be handled or processed. If a DiFC fired (e.g. Yes), then proceed to step B6. Otherwise, if no DiFCs fired (e.g. No), then proceed to step B9.
B6. Determining whether the DiFC that fired points to an AS. If the DiFC points to an AS (e.g. Yes), i.e. the DiFC may include an AS address (e.g. a URI of an AS), then proceed to B7. Otherwise, if the DiFC does not point to an AS (e.g. No), then proceed to B10.
B7. Forward the UR to the AS pointed to by the DiFC for handling or further processing. This ends the network element's handling/processing of the UR.
B8. Determine whether to send the UR to an AS for rejection. If network element determines the UR should be forwarded to an AS (e.g. a default AS when there is no AS address in a DiFC) then proceed to step B9. Otherwise, proceed to step B10.
B9. Forward the UR to the determined AS (e.g. a default AS) for rejection. This ends the network element's handling/processing of the UR.
B10. The network element may process or reject the UR. This may depend on the configuration of the network element based on operator policies. Once the UR is processed or rejected, this ends the network element's handling/processing of the UR.
B11. As iFCs have fired, then the network element continues to process the UR normally.

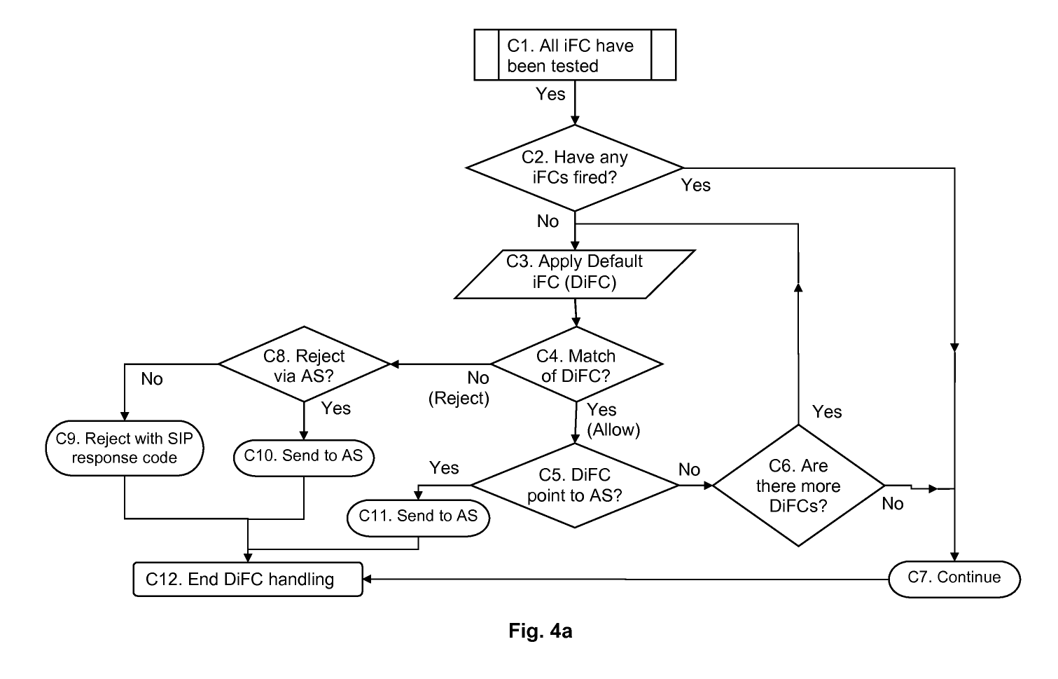

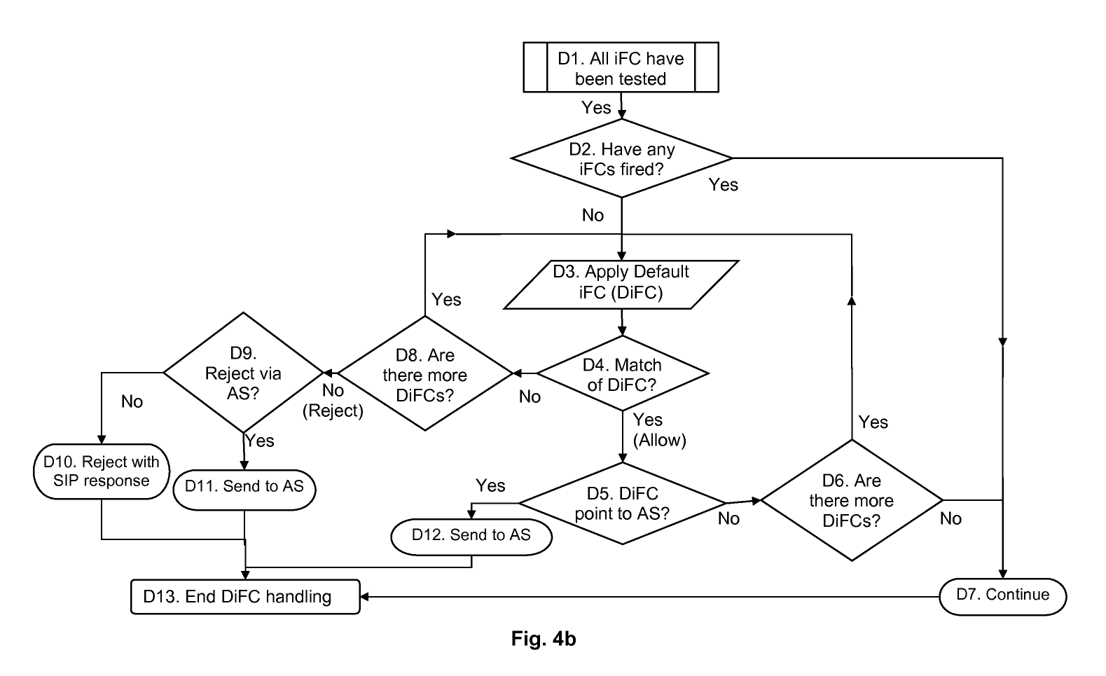

FIG. 4a is a flow diagram illustrating a further example process for operating a network element according to the invention. The network element may be included in an IMS network and have the functionality of an S-CSCF node such that it has access the iFCs (e.g. a collection of iFCs) associated with a user (e.g. from the user profile in the HSS of the IMS network, or locally stored). The IMS network also includes one or more ASs for use in handling user, call or session requests forwarded by the network element. The process includes the steps of:
C1. The network element determines whether all iFCs have been tested or match a received user request (e.g. a call or session request) associated with a UE. If so, proceed to step C2, otherwise wait until all iFCs have been tested or match the received user request.
C2. The network element determines whether any of the iFCs matched/fired. If yes, then an iFC has matched/fired so proceed to step C7 for continuation of normal processing of the user request e.g. perform call signalling/call processing of a call request. If no, then proceed to step C3.
C3. Apply a DiFC from a set of one or more DiFCs to the received user request. The DiFCs may be stored within the network element, or received from another network node (e.g. an HSS). The DiFCs are separate from and may not be considered part of the collection of iFCs associated with the user, user subscription or user profile.
C4. The network element determines whether the received user request matches the selection criteria of the DiFC. The selection criteria are configurable rules or conditions and may be based on information within the received user request, for example: the media type, session type (e.g. originating, terminating etc), SIP method type, SIP header type etc. For example, a selection criterion could be: “All Media types except Media Type “x1” always to be rejected”. As another example of when a match may be found is when an operator has a specific service (e.g. gameZ which uses Media Type X1), and the operator may want to allow the received user request to continue further up in the network (e.g. to the GameZ AS). It is to be appreciated that there are many variations or selection criteria that may be defined by a network operator for catching and handling received user requests that are not recognised by the iFCs associated with a user profile or user. If the received user request does not match the selection criteria of a DiFC, then proceed to step C8. Otherwise, proceed to step C5—i.e. the received user request matched the selection criteria of a DiFC.
C5. If a match was found (e.g. Media was of type “x1”) in step C4, then it is determined whether the DiFC points to an AS (e.g. includes an AS address). For example, the DiFC is checked to see if it contains an “Application Server: Server Name” or AS URI (e.g. address of the GameZ AS). If the DiFC points to an AS, then proceed to step C11, otherwise proceed to step C6.
C6. When no AS address or name is available in a DiFC, then a check is performed to determine whether there are further DiFCs for testing/matching with the received user request. If there are no more DiFCs then proceed to step C7. Otherwise proceed to step C4 using one of the further DiFCs applied to the received user request.
C7. Continue to process the received user request, e.g. continue perform call signalling/call processing for a call request. The network element may continue to process the received user request if it is determined that a decision may be taken by the network element and that there is no need to involve an AS. For example, in the above examples where “continue call signalling/call processing” may occur is if an operator decides that the decision to support “Media Type X1” can be taken by the network element (e.g. S-CSCF), and there is no need to involve an AS (e.g. the operator has an “interworking” agreement with another operator in relation to Media Type X1). Proceed to step C12.
C8. If there is no match, then a decision is made to reject the received user request via an AS or by a direct rejection response sent from the network element (e.g. S-CSCF). If the decision is made to reject the received user request via an AS then proceed to step C10, otherwise, proceed to step C9.
C9. The network element rejects the received user request by sending a rejection response such as a SIP response and/or a response message to the user associated with the received user request. For example, a SIP response rejecting the received user request may be sent (e.g. “403 Forbidden”) or the network element may forward an announcement instructing the user on how to proceed. Proceed to step C12.
C10 The received user request is sent to an AS, then the AS can, based on operator policies decide what to do with the request (e.g. reject with special SIP response or maybe forward to an announcement instructing the user on how to proceed). For example, a SIP response rejecting the received user request may be sent (e.g. “403 Forbidden”) where the server understood the received user request, but is refusing to fulfil it. Proceed to step C12.
C11. The received user request is sent (forwarded) to the AS specified by the corresponding DiFC for further processing/handling/or specific treatment. Proceed to step C12.
C12. Although the network element may perform other tasks or further process the user request (e.g. find the terminating user/network, route to that user network etc.) this is the end of the DiFC handling process.

FIG. 4b is a flow diagram illustrating an example process similar to the process of FIG. 4a with several modifications. The steps of the process performed at the network element are as follows.
D1. Determining whether all iFCs have been tested or match a received user request (e.g. a call or session request) associated with a UE. If so, proceed to step D2, otherwise wait until all iFCs have been tested or match the received user request.
D2. Determining whether any of the iFCs matched/fired. If yes, then an iFC has matched/fired so proceed to step D7 for continuation of normal processing of the request e.g. perform call signalling/call processing of a call request. If no, then proceed to step D3.
D3. Apply a DiFC from a set of one or more DiFCs to the received user request. Proceed to D4. The DiFCs may be stored within the network element, or received from another network node (e.g. an HSS). The DiFCs are separate from and not considered part of the collection of iFCs associated with the user, user subscription or user profile.
D4. Determine whether the received user request matches the selection criteria of the DiFC. The selection criteria may be configurable conditions or rules that are based on, for example: the media type, session type (e.g. originating, terminating etc), SIP method type, SIP header type etc. For example, a selection criterion could be: “All Media types except Media Type “x1” always to be rejected”. As another example of when a match may be found is when an operator has a specific service (e.g. gameZ which uses Media Type X1), and the operator may want to allow the received user request to continue further up in the network (e.g. to the GameZ AS). It is to be appreciated that there are many variations or selection criteria that may be defined by a network operator for catching and handling received user requests that are not recognised by the iFCs associated with a user profile or user. If the received user request does not match the selection criteria of a DiFC, then proceed to step D8. Otherwise, proceed to step D5—i.e. the received user request matched a DiFC.
D5. If a match was found (e.g. Media was of type “x1”) in step D4, then it is determined whether the DiFC points to an AS (e.g. includes an AS address). For example, the DiFC is checked to see if it contains an “Application Server: Server Name” or AS URI (e.g. address of the GameZ AS). If the DiFC points to an AS, then proceed to step D12, otherwise proceed to step D6.
D6. When no AS address or name is available in a DiFC, then a check is performed to determine whether there are further DiFCs for testing/matching with the received user request. If there are no more DiFCs then proceed to step D7, otherwise proceed to step D4 using one of the further DiFCs applied to the received user request.
D7. Continue to process the received user request, e.g. continue perform call signalling/call processing for a call request. The network element may continue to process the received user request if it is determined that a decision may be taken by the network element and that there is no need to involve an AS. For example, in the above examples where “continue call signalling/call processing” may occur is if an operator decides that the decision to support “Media Type X1” can be taken by the network element (e.g. S-CSCF), and there is no need to involve an AS (e.g. the operator has an “interworking” agreement with another operator in relation to Media Type X1). Proceed to D13.
D8. If there is no match, then a check is performed to determine whether there are further DiFCs for testing/matching with the received user request. If there are no more DiFCs then proceed to step D9, otherwise proceed to step D4 using one of the further DiFCs applied to the received user request.
D9. As none of the DiFCs match the received user request, then a decision is made to reject the received user request via an AS or by a direct rejection request sent from the network element (e.g. S-CSCF). If the decision is made to reject the received user request via an AS then proceed to step D11, otherwise, proceed to D10.
D10. The network element rejects the received user request via a rejection message such as a SIP response or sends a response message to the user associated with the received user request. For example, a SIP response rejecting the received user request may be sent (e.g. “403 Forbidden”) or the network element may forward an announcement instructing the user on how to proceed. The network element may also perform other tasks for rejecting the user request. Proceed to D13.
D11. The received user request is sent to an AS, then the AS can, based on operator policies decide what to do with the request (e.g. reject with special SIP response or maybe forward to an announcement instructing the user on how to proceed). For example, a SIP response rejecting the received user request may be sent (e.g. “403 Forbidden”) where the server understood the received user request, but is refusing to fulfil it. Proceed to D13.
D12. The received user request is sent (forwarded) to the AS specified by the corresponding DiFC for further processing/handling/or specific treatment. Proceed to D13.
D13. Although the network element may perform other tasks or further process the user request (e.g. find the terminating user/network, route to that user network etc.) this is the end of the DiFC handling process.

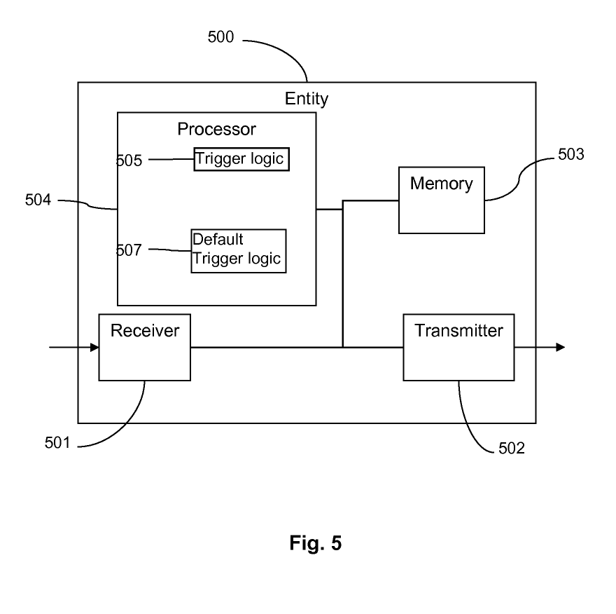

FIG. 5 illustrates schematically an example of a network element 500 suitable for implementing the methods described herein. The network element 500 may be for use in an IMS network including a plurality of ASs and a collection of iFCs associated with a user equipment or a user. The network element 500 may include a receiver 501, a transmitter 502, memory 503, and processing logic 504, where the processing logic 504 being connected to the receiver 501, the transmitter 502 and the memory 503. The memory 503 may be used for storing the collection of iFCs associated with the user. The collection of iFCs may be based on a user profile of the user and downloaded from another network element such as an HSS of the IMS network.

In operation, the receiver 501 is configured to receive a user request (or session request) associated with the user. The processing logic 504 comprises trigger logic 505 and default trigger logic 507. The trigger logic 202 may be configured to apply the collection of iFCs to the user request. The default trigger logic 507 may be configured to determine whether user request or the session associated with the session request is recognised. The default trigger logic 507 may be further configured to apply one or more DiFCs to the user request when the user request or the session associated with the session request is not recognised. The DiFCs including selection criteria defining one or more rules associated with rejecting or allowing processing of the user request (e.g. a session/service request).

The selection criteria of each of the one or more DiFCs may include a default trigger point element including one or more service point triggers defining at least one of the one or more rules for rejecting or allowing processing of the user request when the session associated with the user request is not recognised.

The default trigger logic 507 may be further configured to determine whether the user request matches the selection criteria of an applied DiFC. The default trigger logic 507 may then trigger the transmitter 502 of network element 500 to forward the user request to an AS when the user request matches the selection criteria of the applied DiFC. The applied DiFC includes the AS address. Alternatively, the default trigger logic 507 may be further configured to process or reject the user request when the applied DiFC does not include an AS address.

In addition or alternatively, the default trigger logic 507 may be further configured to determine whether the user request matches the selection criteria of an applied default iFC. The default trigger logic 507 and the transmitter 502 are further configured to forward the user request to an application server when the user request matches the selection criteria of the applied DiFC and the applied DiFC includes the AS address. The default trigger logic 507 may be further configured to process the user request when the user request matches the selection criteria of the applied DiFC and the applied DiFC does not include an AS address.

Additionally, the default trigger logic 507 may be further configured to determine whether a further DiFC may be applied to the user request when the applied DiFC does not include an AS address. The further default iFC may be applied to the user request when it is determined a further DiFC may be applied, and the default trigger logic 507 procedure as described with reference to the applied DiFC is performed using the further DiFC. The default trigger logic 507 may process the user request when it is determined a further DiFC may not be applied to the user request.

Alternatively or additionally, the default trigger logic 507 can be further configured to determine whether the user request matches the selection criteria of an applied default iFC, and to determine whether to reject the user request via an AS when the user request does not match the selection criteria of an applied default iFC. The default trigger logic 507 and transmitter 502 are then further configured to forward the user request to an AS for rejection when it is determined to reject the user request via an AS, or to forward a rejection response to the UE associated with the user request.

Additionally or alternatively, the default trigger logic 507 may determine whether the user request matches the selection criteria of a further applied DiFC. The default trigger logic 507 may then trigger the transmitter 502 to forward the user request to an AS for processing when the user request matches the selection criteria of the further applied DiFC and the further applied DiFC includes the AS address. Alternatively, the default trigger logic 507 and transmitter 502 are further configured to forward the user request to an AS for rejection when the user request does not match the selection criteria of the further applied DiFC and the further applied DiFC includes the AS address.

The memory 503 may be configured to store the DiFCs within the network element 500. Additionally or alternatively, the receiver 501 may be configured to receive the DiFCs from a further node or network element in the IMS network (e.g. an HSS), and the memory is configured to store the DiFCs. This may allow an operator to centrally store and update the DiFCs, such that each network element 500 is configured to update the stored DiFCs in memory 503.

In addition, the default trigger logic 507 and transmitter 502 may be further configured to forward the user request to an AS (e.g. a default AS or a security AS) for rejection when the user request does not match the selection criteria of all further applied DiFCs or all further DiFCs.

Furthermore, the triggering logic 505 may be further configured to determine whether at least one iFC in the collection matches the user request, and forward the user request for normal processing (e.g. forward a call request for normal call processing). The network element 500 may include the functionality of an S-CSCF.

Although the trigger logic 505 and default trigger logic 507 are described separately, it is to be appreciated by the person skilled in the art that may combine the trigger logic 505 with one or more portions or the whole of the default trigger logic 507. Although the processes as described with reference to FIGS. 3a-4b are described as being performed in a network element, it is to be appreciated that the trigger logic 201a-201n and 505 and/or the default trigger logic 203 or 507 may be configured to perform one or more steps of the processes as described with reference to FIGS. 3a-4b.

Embodiments of the present invention can provide a relatively simple and efficient mechanism for allowing a network operator to minimise the complexity of iFC configuration for each user while enabling the network to take into account user or session requests that are unknown or unrecognised by the network.

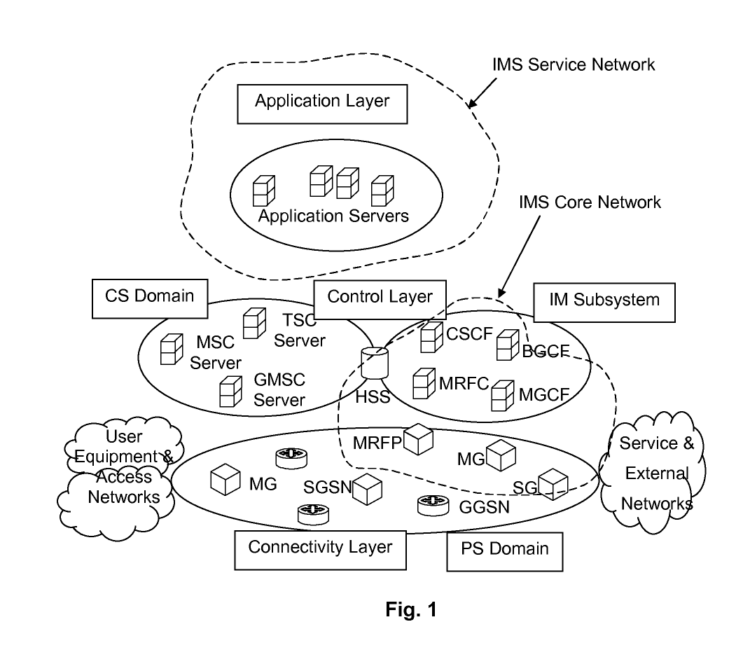

It is to be appreciated that the network element 200 or 500 may comprise or represent any network node, device, function, or entity in a telecommunications network or IMS network, examples of which may include the elements that make up core network(s), access network(s) such as packet or circuit switched network(s), IP based networks, 2G, 3G, 4G and next generation networks, Evolved Packet Core networks, IMS core network(s), IMS service network(s), and service and external networks and the like. Other examples of network elements are those network elements illustrated in FIG. 1 including, but not limited to, HSSs, ASs, I-CSCFs, P-CSCFs, S-CSCFs, SGWs, GGSNs, SSGN, SBGs, MRFs, MGs/MGWs, MSs, MGCFs, BGCFs, eNBs, RBSs, RNCs, Node Bs, SGWs, or MMEs and other core network, access network devices, entities, nodes, elements or the like.

The methods and/or processes as described herein may be implemented in a network element as described herein or the above mentioned or similar network nodes, elements or entities as one or more computer program(s) comprising software or instruction code, which when executed on one or more processor(s) (e.g. in a network element, a UE or any other suitable network apparatus or device), performs the steps of one or more of the methods or processes as described. The computer program(s) may be stored on one or more computer readable medium(s).

Although the invention has been described in terms of examples or preferred embodiments as set forth above, it should be understood that these examples or embodiments are illustrative only and that the claims are not limited to those examples or embodiments. Those skilled in the art will be able to make modifications and alternatives in view of the disclosure which are contemplated as falling within the scope of the appended claims. Each feature disclosed or illustrated in the present specification may be incorporated in the invention, whether alone or in any appropriate combination with any other feature disclosed or illustrated herein.

1. A method for operating a network element in an Internet Protocol Multimedia Subsystem, IMS, network including a plurality of application servers and a collection of Initial Filter Criteria, iFC, the method comprising:
receiving a user request associated with a user;
applying a collection of Initial Filter Criteria, iFC, associated with the user to the user request;
determining whether the session associated with the user request is recognised;
applying one or more default iFCs to the user request when the session associated with the user request is not recognised, wherein the default iFCs comprise selection criteria defining one or more rules associated with rejecting or processing the user request.

2. The method according to claim 1, wherein the step of applying one or more default iFCs to the user request further comprises:
determining whether the user request matches the selection criteria of an applied default iFC;
forwarding the user request to an application server, AS, for processing or rejection when the user request matches the selection criteria of the applied default iFC and the applied default iFC includes the AS address; and
processing the user request by the network element when the user request matches the selection criteria of the applied default iFC and the applied default iFC does not include an AS address.

3. The method according to claim 2, wherein the step of applying one or more default iFCs to the user request further comprises:
determining whether a further default iFC may be applied to the user request when the applied default iFC does not include an AS address;
applying the further default iFC to the user request when it is determined a further default iFC may be applied; and
processing the user request by the network element when it is determined a further default iFC may not be applied to the user request.

4. The method according to claim 1, wherein the step of applying one or more default iFCs to the user request further comprises:
determining whether the user request matches the selection criteria of an applied default iFC;
determining whether to reject the user request via an AS when the user request does not match the selection criteria of an applied default iFC;
forwarding the user request to an AS for rejection when the user request is determined for rejection by the AS; and
forwarding a rejection response from the network element to the UE associated with the user request.

5. The method according to claim 4, wherein the step of forwarding the user request to an AS for rejection further includes forwarding the user request to the AS for rejection when the user request does not match the selection criteria of all further applied default iFCs.

6. The method according to claim 1, wherein the selection criteria of each of the one or more default iFCs comprises a default trigger point element including one or more service point triggers that define at least one of the one or more rules for rejecting or allowing processing of the user request when the session associated with the user request is not recognised.

7. The method according to claim 1, wherein the step of applying the collection of iFCs to the user request further comprises the steps of:
determining the session associated with the user request to be recognised when the user request matches at least one iFC in the collection;
continuing processing of the user request when the session associated with the user request is recognised.

8. The method to claim 1, further comprising:
receiving the one or more default iFCs from a further network element in the IMS network; and
storing the one or more default iFCs.

9. The network element according to claim 8, further comprising updating the one or more of the stored default iFCs.

10. The method according to claim 1, wherein the network element includes the functionality of a Serving Call Session Control Function.

11. A network element for use in an Internet Protocol Multimedia Subsystem, IMS, network including a plurality of application servers, the network element comprising:
a receiver, a transmitter, memory, and processing logic, the processing logic being connected to the receiver, the transmitter and the memory, wherein:
the receiver is configured to receive a user request associated with a user; and
the processing logic comprises:
trigger logic configured to apply a collection of Initial Filter Criteria, iFC, to the user request;
default trigger logic configured to:
determine whether the session associated with the user request is recognised; and
apply one or more default iFCs to the user request when the session associated with the user request is not recognised, wherein the default iFCs comprise selection criteria defining one or more rules associated with rejecting or processing of the user request.

12. The network element according to claim 11, wherein:
the default trigger logic is further configured to:
determine whether the user request matches the selection criteria of an applied default iFC;
the default trigger logic and the transmitter are further configured to forward the user request to an application server when the user request matches the selection criteria of the applied default iFC and the applied default iFC includes the application server address; and
the default trigger logic is further configured to process the user request when the user request matches the selection criteria of the applied default iFC and the applied default iFC does not include an AS address.

13. The network element according to claim 12, wherein:
the default trigger logic is further configured to:
determine whether a further default iFC may be applied to the user request when the applied default iFC does not include an AS address;
apply the further default iFC to the user request when it is determined a further default iFC may be applied; and
process the user request when it is determined a further default iFC may not be applied to the user request.

14. The network element according to claim 11, wherein:
the default trigger logic is further configured to:
determine whether the user request matches the selection criteria of an applied default iFC;
determine whether to reject the user request via an AS when the user request does not match the selection criteria of an applied default iFC;
the default trigger logic and transmitter are further configured to:
forward the user request to an AS for rejection when it is determined to reject the user request via an AS;
forward a rejection response to the UE associated with the user request.

15. The network element according to claim 14, wherein the default trigger logic and transmitter are further configured to forward the user request to the application server for rejection when the user request does not match the selection criteria of all further applied default iFCs.

16. The network element according to claim 11, wherein the selection criteria of each of the one or more default iFCs comprises a default trigger point element including one or more service point triggers defining at least one of the one or more rules for rejecting or allowing processing of the user request when the session associated with the user request is not recognised.

17. The network element according to claim 11, wherein the triggering logic is further configured to:
determine the session associated with the user request to be recognised when at least one iFC in the collection matches the user request; and
forward the user request for normal call processing when the session associated with the user request is recognised.

18. The network element according to claim 11, wherein:
the receiver is configured to receive the one or more default iFCs from a further network element in the IMS network; and
the memory is configured to store the one or more default iFCs.

19. The network element according to claim 18, wherein the receiver and processor are further configured to update one or more of the stored default iFCs.

20. The entity according to claim 11, wherein the network element includes the functionality of a Serving Call Session Control Function.
